(19) United States
(12) Patent Application Publication
(10) Pub. No.: US 2019/0207262 A1
(43) Pub. Date: Jul. 4, 2019

(54) BATTERY CELL COMPRISING AN ELECTROLYTE COMPRISING A METAL SALT

(71) Applicant: RENAULT s.a.s., Boulogne-Billancourt (FR)

(72) Inventor: Bruno DELOBEL, Paris (FR)

(73) Assignee: RENAULT s.a.s., Boulogne-Billancourt (FR)

(21) Appl. No.: 16/314,973

(22) PCT Filed: Jun. 9, 2017
(86) PCT No.: PCT/FR2017/051479

§ 371 Date: Jan. 16, 2019

(30) Foreign Application Priority Data
Jul. 5, 2016 (FR) 1656414

(51) Int. Cl. H01M 10/0568; H01M 10/0567; H01M 10/0569; H01M 10/0525; H01M 4/587

(52) U.S. Cl. CPC H01M 10/0568; H01M 10/0567; H01M 10/0569; H01M 2004/027; H01M 4/587; H01M 2300/0025; H01M 10/0525

(57) ABSTRACT

The invention relates to a Li-ion battery cell comprising a material for a positive electrode, a carbon-based material for a negative electrode, a separator and an electrolyte, said electrolyte comprising:—at least one additive;—at least one lithium salt;—at least one solvent; and—at least one electrically neutral metal salt of formula (I): wherein:—A is a metal chosen from Mn, Fe, Ni, Co, Cu, Cr, Ag and Zn;—B is chosen from Cl, ClO₄, TFSI, [N(SO₂″R)₂] where R=C_{z}F_{2z}+1 or 1≤z<8, FSI, CF₃SO₃ and CF₃CO₂.

Aₓ^{a+}B_{y}^{b-} (I)

The invention relates to the general field of rechargeable lithium-ion (Li-ion) batteries.

The invention relates more specifically to electrolytes for Li-ion batteries comprising a positive electrode, a carbon-based negative electrode and a separator.

Conventionally, Li-ion batteries comprise one or more positive electrodes, one or more negative electrodes, an electrolyte and a separator composed of a porous polymer or of any other appropriate material in order to avoid any direct contact between the electrodes.

Li-ion batteries are increasingly used as an autonomous energy source, in particular in applications related to electric mobility. This trend is explained in particular by mass and volume energy densities which are markedly greater than those of conventional nickel-cadmium (Ni—Cd) and nickel-metal hydride (Ni—MH) batteries, an absence of memory effect, low self-discharge in comparison with other batteries and also a fall in the cost at the kilowatt-hour related to this technology.

The electrolytes generally used in Li-ion batteries comprise one or more lithium salt(s), one or more solvent(s) and one or more additives.

The most well known additives are propane sultone and vinylene carbonate. They are employed in order to improve the quality of a layer known as “Solid Electrolyte Interphase” (SEI) at the surface of the negative electrode. The formation of a solid and stable SEI is necessary for the purpose of obtaining good electrochemical performance qualities. This is because a deterioration in the SEI, probably due to secondary reactions at the electrode/electrolyte interface, results in a decline in the performance qualities.

Unfortunately, these additives do not make it possible to solve all the problems, in particular with regard to the impedance of the battery cell, which is not sufficiently stabilized, or also with regard to the resistance of the electrolyte.

The document WO 2015/134783 discloses a surface-treated electrode active material intended to be used in a Li-ion battery. The electrode active material comprises an ionically conductive layer comprising a polyvalent metal. The surface-treated electrode active material makes it possible to improve the retention of capacity and the lifetime of the Li-ion battery and also reduces the undesirable reactions at the surface of the electrode active material.

This document also describes an electrolyte comprising a metal salt according to a concentration ranging from 0.01M to 0.2M.

This document also specifies that said electrolyte is used in a cell comprising a negative electrode based on a chemical entity chosen from lithium titanate, lithium cobalt oxide, lithium manganese oxide, lithium iron phosphate, lithium nickel manganese cobalt oxide and lithium nickel cobalt aluminum oxide.

It would thus be advantageous to provide a Li-ion battery cell comprising a specific electrolyte which makes it possible to improve the electrochemical performance qualities of said cell, in particular in terms of retention of capacity but also with regard to the impedance of the cell.

A subject matter of the invention is thus a Li-ion battery cell comprising a material for a positive electrode, a material for a carbon-based negative electrode, a separator and an electrolyte, said electrolyte comprising:
at least one additive;
at least one lithium salt chosen from lithium bis[(trifluoromethyl)sulfonyl]imide (LiN(CF₃SO₂)₂), lithium trifluoromethanesulfonate (LiCF₃SO₃), lithium bis(oxalato)borate (LiBOB), lithium difluoro(oxolato)borate (LiDFOB), lithium bis(perfluoroethylsulfonyl)imide (LiN(CF₃CF₂SO₂)₂), LiClO₄, LiAsF₆, LiPF₆, LiBF₄, LiI, LiCH₃SO₃, LiB(C₂O₄)₂, LiR_{F}SOSR_{F}, LiN(R_{F}SO₂)₂ or LiC(R_{F}SO₂)₃, R_{F} being a group chosen from a fluorine atom and a perfluoroalkyl group comprising from 1 to 8 carbon atoms;
at least one solvent; and
at least one electronically neutral metal salt of formula (I):

Aₓ^{a+}B_{y}^{b-} (I),

in which:
A is a metal chosen from Mn, Fe, Ni, Co, Cu, Cr, Ag and Zn;
B is chosen from Cl, ClO₄, TFSI (bis(trifluoromethanesulfonyl)imide), [N(SO₂—R)₂] with R=C₂F_{2z+1} where 1≤z≤8, FSI (bis(fluorosulfonyl)imide), CF₃SO₃ and CF₃CO₂;
a is an integer ranging from 1 to 3;
b is equal to 1;
x is equal to 1; and
y is an integer ranging from 1 to 3

Another subject matter of the invention is a Li-ion battery comprising the cell according to the invention.

A subject matter of the invention is also the use of the manganese bis(trifluoromethanesulfonyl)imide salt Mn(TFSI)₂ as additive for improving the retention of capacity of a Li-ion battery cell.

Other advantages and characteristics of the invention will become more clearly apparent on examining the detailed description and the appended drawings, in which:

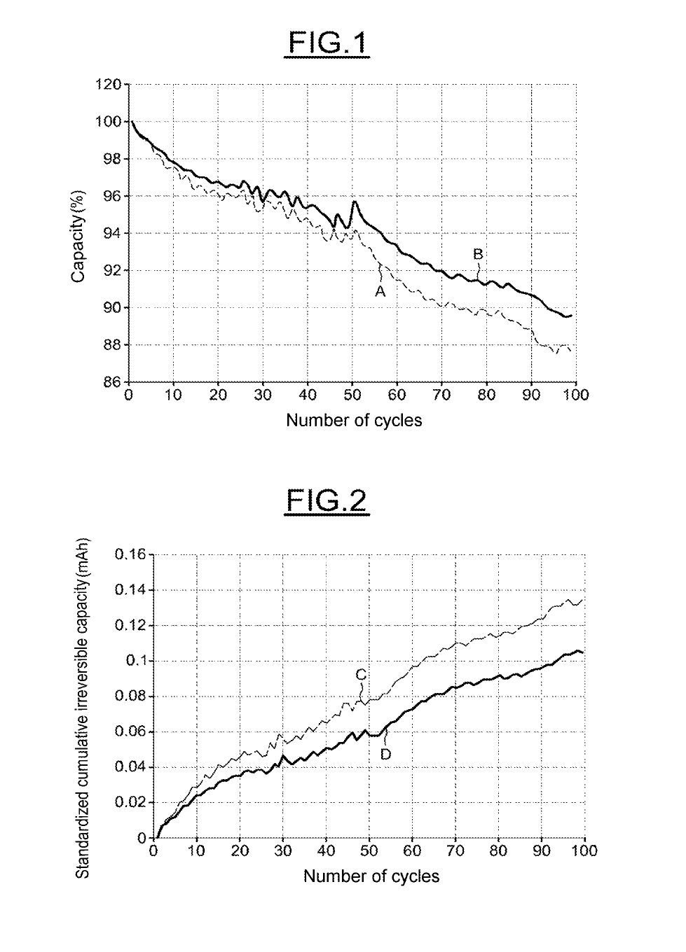

FIG. 1 is a graph showing a change in the capacity of Li-ion battery cells comprising different electrolytes as a function of the number of charge and discharge cycles,

FIG. 2 is a graph showing the change in the cumulative irreversible capacity of Li-ion battery cells comprising different electrolytes as a function of the number of charge and discharge cycles,

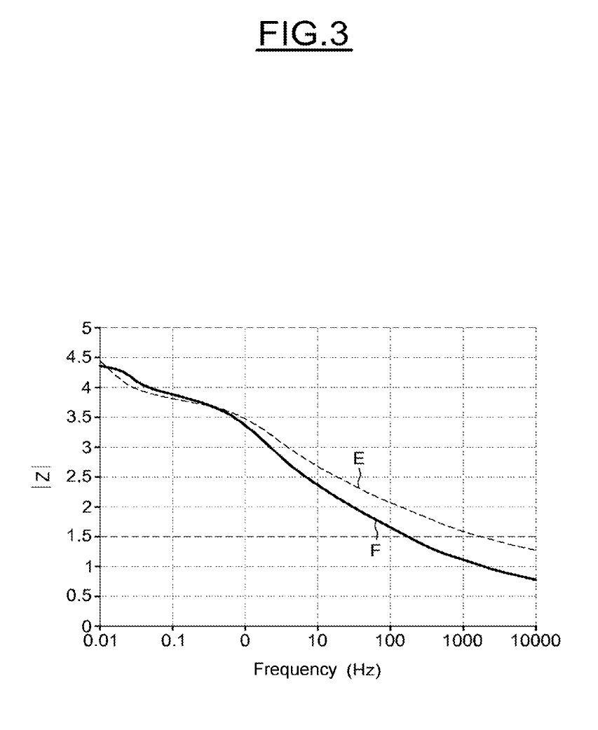

FIG. 3 is a graph showing the change in the impedance of Li-ion battery cells comprising different electrolytes as a function of the frequency.

In the description of the invention, the term “based on” or “-based” is synonymous with “predominantly comprising”.

It is furthermore specified that the expression “from to . . . ” used in the present description should be understood as including each of the limits mentioned and the expression “between . . . and . . . ” should be understood as excluding each of the limits mentioned.

The cell according to the invention comprises an electrolyte comprising at least one additive, at least one lithium salt, at least one solvent and at least one metal salt of formula (I) as mentioned above.

Preferably, the additive is chosen from vinylene carbonate, propane sultone and their mixture.

According to a specific embodiment, the lithium salt is lithium hexafluorophosphate.

Advantageously, said solvent is chosen from ethers, nitriles, sulfones, ethylene carbonate, ethyl methyl carbonate, dimethyl carbonate, diethyl carbonate and their mixtures, preferably chosen from ethylene carbonate, ethyl methyl carbonate, dimethyl carbonate, diethyl carbonate and their mixtures.

As indicated above, the cell according to the invention comprises at least one electronically neutral metal salt of formula (I): Aₓ^{a+}B_{y}^{b-}(I). The letter a denotes the charge of the element A and the letter b denotes the charge of the element B. The letter x denotes the number of element(s) A within the formula (I) and the letter y denotes the number of element(s) B within the formula (I).

in order to ensure the electrical neutrality of the metal salt of formula (I) as mentioned above, the relationship a*x=b*y has to be observed.

Preferably, the element A of the metal salt of formula (I) is Mn.

Preferably, the element B of the metal salt of formula (I) is bis(trifluoromethanesulfonyl)imide (TFSI).

Preferably, y is equal to 2.

Preferably, a*x is equal to 2.

Advantageously, the metal salt of formula (I) is the manganese bis(trifluoromethanesulfonyl)imide salt Mn(TFSI)₂.

Preferably, the concentration of the metal salt ranges from 0.0001M to 0.01M, more advantageously from 0.001M to 0.005M.

Advantageously, the cell according to the invention comprises an electrolyte comprising at least one additive chosen from vinylene carbonate, propane sultone and their mixture, and lithium hexafluorophosphate.

According to a specific embodiment of the invention, the cell according to the invention comprises an electrolyte comprising lithium hexafluorophosphate and at least one solvent chosen from ethylene carbonate, ethyl methyl carbonate, dimethyl carbonate, diethyl carbonate and their mixtures.

Preferably, the cell according to the invention comprises at least one solvent chosen from ethylene carbonate, ethyl methyl carbonate, dimethyl carbonate, diethyl carbonate and their mixtures, and manganese bis(trifluoromethanesulfonyl)imide salt Mn(TFSI)₂.

Preferably, the cell according to the invention comprises at least one solvent chosen from ethylene carbonate, ethyl methyl carbonate, dimethyl carbonate, diethyl carbonate and their mixtures, and manganese bis(trifluoromethanesulfonyl)imide salt Mn(TFSI)₂ according to a concentration ranging from 0.001M to 0.005M.

Particularly advantageously, the cell according to the invention comprises an electrolyte comprising at least one additive chosen from vinylene carbonate, propane sultone and their mixture, and lithium hexafluorophosphate, at least one solvent chosen from ethylene carbonate, ethyl methyl carbonate, dimethyl carbonate, diethyl carbonate and their mixtures, and manganese bis(trifluoromethanesulfonyl)imide salt Mn(TFSI)₂.

Preferably, the material for a positive electrode is based on an active material represented by a lithium metal oxide of a metal chosen from nickel, cobalt, manganese and their mixtures.

Advantageously, the active material for a positive electrode is LiNi_{0.5}Mn_{0.3}Co_{0.2}O₂.

Besides the active material, the material for a positive electrode can also comprise carbon fibers. Preferably, these are vapor grown carbon fibers (VGCFs) sold by Showa Denko. Other appropriate types of carbon fibers can be carbon nanotubes, doped nanotubes (optionally doped with graphite), carbon nanofibers, doped nanofibers (optionally doped with graphite), single-walled carbon nanotubes or multi-walled carbon nanotubes. The methods of synthesis relating to these materials can include arc discharge, laser ablation, a plasma torch and chemical vapor deposition.

The material for a positive electrode can additionally comprise one or more binders.

Preferably, the binder(s) can be chosen from polybutadiene/styrene latexes and organic polymers, and preferably from polybutadiene/styrene latexes, polyesters, polyethers, polymer derivatives of methyl methacrylate, polymer derivatives of acrylonitrile, carboxymethylcellulose and its derivatives, polyvinyl acetates or polyacrylate acetate, polyvinylidene fluorides and their mixtures.

Preferably, the binder is polyvinylidene fluoride (PVdF).

According to a preferred embodiment of the invention, the material for a negative electrode is based on graphite. The graphite carbon can be chosen from synthetic graphite carbons and natural graphite carbons, starting from natural precursors, followed by a purification and/or by a posttreatment. Other active materials based on carbon can be used, such as pyrolytic carbon, amorphous carbon, active charcoal, coke, coal pitch and graphene. Mixtures of graphite with one or more of these materials are possible. Materials having a core/shell structure can be used when the core comprises high-capacity graphite and when the shell comprises a material based on carbon which protects the core from the degradation relating to the repeated phenomenon of the intercalation/deintercalation of the lithium ions.

The material for a negative electrode based on carbon can additionally comprise one or more binders as for the positive electrode.

The binders described above for the positive electrode can be used for the negative electrode.

Preferably, the binders used are carboxymethylcellulose (CMC) and the Styrofan® latex, that is to say a carboxylated styrene/butadiene copolymer.

Advantageously, the separator is composed of porous polymers, preferably of polyethylene and/or of polypropylene.

Another subject matter of the invention is a Li-ion battery comprising at least one cell as defined above.

A subject matter of the invention is also the use of the manganese bis(trifluoromethanesulfonyl)imide salt Mn(TFSI)₂ as additive for improving the retention of capacity of a Li-ion battery cell.

The present invention is illustrated without implied limitation by the following examples.

### EXAMPLES

### Preparation of the Positive Electrode

An active material for a positive electrode of formula LiNi_{0.5}Mn_{0.3}Co_{0.2}O₂ is used. The electrode is prepared by mixing 95% by weight of active material, 2.5% by weight of a Super P® carbon additive and 2.5% by weight of polyvinylidene fluoride dissolved in N-methyl-2-pyrrolidone (NMP).

The electrode is manufactured by depositing the mixture on an aluminum sheet with a thickness of 20 microns. The electrodes are dried and compressed by calendering at 80° C.

### Preparation of the Negative Electrode

An active graphite material is provided by Hitachi MAGE. The electrode is manufactured by mixing 97% by weight of graphite, 1% by weight of a Super P® carbon additive, 1% by weight of carboxymethylcellulose (CMC) and 1% by weight of Styrofan® latex, that is to say a carboxylated styrene/butadiene copolymer.

The resulting mixture is deposited on a copper sheet with a thickness of 15 microns, then dried and compressed by calendering at 80° C.

### Separator

The Celgard® 2500 separator is used in order to prevent any short circuit between the positive electrode and the negative electrode during the charge and discharge cycles.

The Celgard® 2500 separator is a membrane with a thickness of 25 microns composed of polypropylene.

### Electrolyte

Two electrolytes are used to carry out the comparative tests, the compositions of which are given in table 1:

TABLE 1

| Electrolyte | 1 (comparative) | 2 (invention) |
|---|---|---|
| LiPF₆ (M) | 1 | 1 |
| EC/DEC (ratio by volume) | 1/1 | 1/1 |
| Vinylidene carbonate (% by weight) | 2 | 2 |
| Mn(TFSI)₂ (mM) | — | 5 |

The electrolyte 1 is composed of 1M of lithium salt LiPF₆ dissolved in a mixture of ethylene carbonate and diethyl carbonate (EC/DEC) according to a 1/1 ratio by volume, and of 2% by weight of vinylidene carbonate.

The electrolyte 2 is composed of 1M of lithium salt LiPF₆ dissolved in a mixture of ethylene carbonate and diethyl carbonate (EC/DEC) according to a 1/1 ratio by volume, of 2% by weight of vinylidene carbonate, and of 5 mM of manganese bis(trifluoromethanesulfonyl)imide salt Mn(TFSI)₂.

The cells are finally assembled by stacking the positive electrode as prepared above, the negative electrode as prepared above and the Celgard® 2500 separator, located between the two electrodes. The separator is impregnated with the electrolyte as described above.

Thus, two Li-ion battery cells are prepared. The comparative cell 1 contains the electrolyte 1 while the cell 2 according to the invention contains the electrolyte 2.

### Electrochemical Performance Qualities of Li-Ion Battery Cells

### Evaluation of the Capacity as a Function of the Number of Cycles

FIG. 1 represents a graph showing the change in the capacity of the Li-ion battery cells 1 and 2 as a function of the number of charge and discharge cycles.

### Method

A cycling process was used. The first cycle, or activation cycle, took place at voltages ranging from 4.2 to 2.5 V at a C/10 cycling rate. The following charge and discharge cycles took place at voltages ranging from 4.2 to 2.5 V at a C/2 cycling rate.

### Result

Thus, FIG. 1 clearly shows that a better retention of capacity is obtained for the battery cell 2 (curve B) according to the invention, in comparison with that of the comparative battery cell 1 (curve A). This is because, after 100 charge and discharge cycles, a retention of capacity of the order of 90% is observed for the cell 2 whereas a retention of capacity of the order of 88% is observed for the cell 1.

The analysis of FIG. 1 clearly shows the beneficial effect of the manganese bis(trifluoromethanesulfonyl)imide salt Mn(TFSI)₂ on the electrochemical behavior of a Li-ion battery cell.

Thus, the cell according to the invention exhibits excellent properties in terms of retention of capacity.

### Evaluation of the Cumulative Irreversible Capacity as a Function of the Number of Cycles

FIG. 2 represents a graph showing the change in the cumulative irreversible capacity of the Li-ion battery cells 1 and 2 as a function of the number of charge and discharge cycles.

### Method

A cycling process was used. The first cycle, or activation cycle, took place at voltages ranging from 4.2 to 2.5 V at a C/10 cycling rate. The following charge and discharge cycles took place at voltages ranging from 4.2 to 2.5 V at a C/2 cycling rate.

### Result

Thus, FIG. 2 clearly shows that a lower cumulative irreversible capacity is obtained for the battery cell 2 (curve D) according to the invention, in comparison with that of the comparative battery cell 1 (curve C). This is because, after 100 charge and discharge cycles, an irreversible capacity of the order of 0.105 mAh is measured for the cell 2 whereas an irreversible capacity of the order of 0.135 mAh is measured for the cell 1.

The analysis of FIG. 2 clearly shows the beneficial effect of the manganese bis(trifluoromethanesulfonyl)imide salt Mn(TFSI)₂ on the electrochemical behavior of the Li-ion battery cell.

Thus, the cell according to the invention exhibits excellent properties in terms of cumulative irreversible capacity.

### Evaluation of the Impedance of a Cell as a Function of the Frequency

FIG. 3 represents a graph showing the change in the impedance of the Li-ion battery cells 1 and 2 as a function of the frequency. The impedance was measured according to a PEIS procedure with a signal of +/−5 mv.

### Result

Thus, FIG. 3 clearly shows that a stabilization of the impedance is observed at high frequency for the battery cell 2 (curve F) according to the invention, in comparison with that of the comparative battery cell 1 (curve E). This stabilization of the impedance reflects a stabilization “of the electrolyte”. This represents an advantage as said stabilization results in a decrease in the side reactions within the electrolyte which lead to a decomposition of said electrolyte. This decrease in the side reactions makes it possible to delay the death undergone by the cell, that is to say the moment when the cell undergoes a degradation such that it is no longer capable of functioning.

The analysis of FIG. 3 clearly shows the beneficial effect of the manganese bis(trifluoromethanesulfonyl)imide salt Mn(TFSI)₂ on the electrochemical behavior of the Li-ion battery cell. It can thus be deduced from the analysis of the three combined figures that the cell according to the invention comprising the specific electrolyte as described above exhibits excellent properties in terms of retention of capacity and of impedance.

1. A Li-ion battery cell, comprising:
a material for a positive electrode,
a material for a carbon-based negative electrode,
a separator and
an electrolyte,
wherein the electrolyte comprises:
an additive;
a lithium salt selected from the group consisting of lithium bis[(trifluoromethyl)sulfonyl]imide (LiN(CF₃SO₂)₂), lithium trifluoromethanesulfonate (LiCF₃SO₃), lithium bis(oxalato)borate (LiBOB), lithium difluoro(oxolato)borate (LiDFOB), lithium bis(perfluoroethylsulfonyl)imide (LiN(CF₃CF₂SO₂)₂), LiClO₄, LiAsF₆, LiPF₆, LiBF₄, LiI, LiCH₃SO₃, LiB(C₂O₄)₂, LiR_{F}SOSR_{F}, LiN(R_{F}SO₂)₂ and LiC(R_{F}SO₂)₃, wherein R_{F} is selected from the group consisting of a fluorine atom and a perfluoroalkyl group comprising from 1 to 8 carbon atoms;
a solvent; and
an electronically neutral metal salt of formula (I):
a_{X}^{A+}b_{Y}^{B-} (I),
wherein
A is a metal selected from the group consisting of Mn, Fe, Ni, Co, Cu, Cr, Ag and Zn;
B is selected from the group consisting of Cl, ClO₄, TFSI, [N(SO₂—R)₂] wherein R is C₂F_{2z+1} where 1≤Z≤8, FSI, CF₃SO₃ and CF₃CO₂;
a is an integer ranging from 1 to 3;
b is equal to 1;
x is equal to 1; and
y is an integer ranging from 1 to 3.

2. The cell of claim 1,
wherein the additive is at least one selected from the group consisting of vinylidene carbonate, and propane sultone.

3. The cell of claim 1,
wherein the lithium salt is lithium hexafluorophosphate.

4. The cell of claim 1,
wherein the solvent is at least one selected from the group consisting of an ether, a nitrile, a sulfone, sulfones, ethylene carbonate, ethyl methyl carbonate, dimethyl carbonate, and diethyl carbonate.

5. The cell of claim 1, wherein A of the electronically neutral metal salt is Mn.

6. The cell of claim 1, wherein B of the electronically neutral metal salt is bis(trifluoromethanesulfonyl)imide.

7. The cell of claim 1, wherein y is equal to 2.

8. The cell of claim 1, wherein the electronically neutral metal salt is manganese bis(trifluoromethanesulfonyl)imide salt Mn(TFSI)₂.

9. The cell of claim 1, wherein a concentration of the electronically neutral metal salt ranges from 0.0001M to 0.01M.

10. The cell of claim 1, wherein the material for the carbon-based negative electrode is based on graphite.

11. The cell of claim 1, wherein the separator is composed of porous polymers.

12. A Li-ion battery, comprising:
the cell of claim 1.

13. A Li-ion battery cell, comprising:
manganese bis(trifluoromethanesulfonyl)imide salt Mn(TFSI)₂ as an additive.
